(19) United States
(12) Patent Application Publication
(10) Pub. No.: US 2014/0214940 A1
(43) Pub. Date: Jul. 31, 2014

(54) NETWORKED DEVICES MATCHING CAPABILITIES WITH TASKS

(71) Applicant: SONY CORPORATION, Tokyo (JP)

(72) Inventors: Seth Guy Hill, La Mesa, CA (US); Andy Nguyen, San Diego, CA (US); Sivaraman Varatharajan, San Diego, CA (US); Sivakumar Murugesan, San Diego, CA (US); Brian Scott Voss, Emeryville, CA (US)

(73) Assignee: SONY CORPORATION, Tokyo (JP)

(21) Appl. No.: 13/755,325

(22) Filed: Jan. 31, 2013

(51) Int. Cl. H04L 29/06

(52) U.S. Cl. CPC H04L 65/403
USPC 709/204

(57) ABSTRACT

Devices in a local network can cooperatively share functionality by advertising their available services and current service needs with an agent being executed in the network. The network can be automatically configured by device discovery or manually configured by a user.

### I. FIELD OF THE INVENTION

The present application relates generally to networked devices in which an agent runs to match capabilities with required tasks.

### II. BACKGROUND OF THE INVENTION

Despite the growing capabilities of modern electronic devices, the conundrum remains that a device may require capability it does not have to execute a function it is intended to execute. A simple example is data storage in a very small device, in which a small implantable device in a patient may function to gather data as intended but owing to lack of storage real estate be unable to store all the data as it accumulates over time.

### SUMMARY OF THE INVENTION

A network device includes a computer processor and a computer readable storage medium accessible to the processor and bearing instructions which when executed by the processor to cause the processor to establish, with at least a partner device, a network, and to record a network location of an agent. The processor communicates to the agent capabilities of the network device and/or requirements or functionalities required by the network device to request execution thereof by other devices in the network. In response to a request for a service functionality from the partner device and responsive to a determination that the network device is capable of satisfying the request, the device supplies to the partner device the service functionality. In response to a reply to a request for a service functionality issued by the processor and responsive to a determination that the partner device is capable of satisfying the request, the device instructs the partner device to execute the service functionality.

In some embodiments the processor is configured to establish the network automatically using a device discovery protocol. Such a network may be local and ad hoc. In other embodiments the processor is configured to establish the network at least in part by using a user-input definition of which devices are to be in the network.

Devices in the network can be configured to negotiate with each other as to which device will execute the agent. A network location for the agent can be defined by user input.

In another aspect, an agent executes on a computing device to configure the computing device to receive from devices in a network requests for services and to receive from devices in the capabilities to perform services. The computing device is configured to determine if a request for a service from a requesting device matches a capability of a first device and a second device, and responsive to a determination that the request for a service from the requesting device matches a capability of the first device but does not match the capability of the second device, cause the first device to supply the capability for the requesting device. Responsive to a determination that the request for a service from the requesting device matches a capability of the first device and matches a capability of the second device, the computing device executing the agent selects the first device to supply the capability for the requesting device based on at least one selection criterion.

In another aspect, a device includes a computer processor, a display controlled by the processor, and a computer readable storage medium accessible to the processor and bearing instructions which when executed by the processor to cause the processor to present on the display a first user interface (UI) providing an option of configuring the device to participate in functionality sharing with other devices in a network. Responsive to selection of configuring the device to participate in functionality sharing with other devices in the network, the processor presents on the display a second UI providing plural options for selecting functionality sharing behaviors.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIGS. 2 and 3 are flow charts of example logic according to present principles; and

FIGS. 4-7 illustrate various example user interfaces according to present principles.

### DETAILED DESCRIPTION OF THE PREFERRED EMBODIMENT

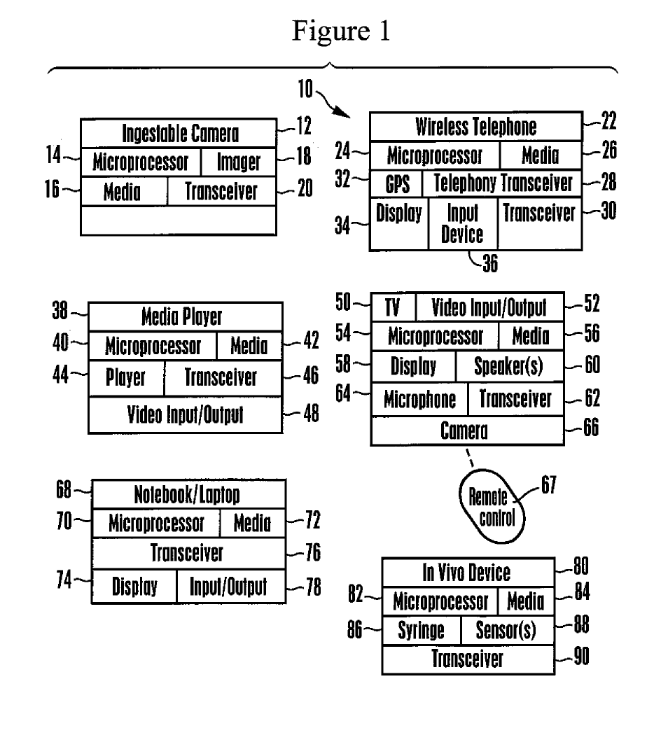

Referring initially to FIG. 1, a system 10 is shown with plural devices in a local ad hoc network for sharing functionality among themselves. The network may not be ad hoc in other implementations, but rather may be predefined.

In any case, without limitation a first device 12 may be implemented by an ingestable camera 12 that a patient can swallow or that can be otherwise implanted in the patient to image internal body structure of the patient. The device 12 may include a processor 14 accessing a disk-based or solid state computer readable storage medium 16 to execute logic for controlling an imager 18, such as but not limited to a charge coupled device (CCD). The processor 14 may communicate with other devices in the system 10 through one or more transceivers 20 (only one transceiver shown for clarity), which may be a wireless transceiver such as but not limited to WiFi transceiver, Bluetooth transceiver, and the like.

A second example device 22 in the system 10 may be implemented by a wireless telephone. The device 22 may include a processor 24 accessing a disk-based or solid state computer readable storage medium 26 to execute logic for controlling a wireless telephony transceiver 28, such as but not limited to a code division multiple access (CDMA) transceiver, a global system for mobile communication (GSM) transceiver, an orthogonal frequency division multiple (OFDM) transceiver, or other appropriate telephony transceiver. The processor 24 may communicate with other devices in the system 10 through one or more transceivers 30 (only one transceiver shown for clarity), which may be a wireless transceiver such as but not limited to WiFi transceiver, Bluetooth transceiver, and the like. The device 22 may further include a position receiver such as but not limited to global positioning satellite (GPS) receiver 32 for receiving geographic position of the device 22, a display system 34 for presenting visual and/or audio data to a human user, and an input device 36, such as a keypad and/or touch screen capability within the display system 34.

Yet a third device 38 may be implemented by a media player such as but not limited to a video disk player. The device 38 may include a processor 40 accessing a disk-based or solid state computer readable storage medium 42 to execute logic for controlling a player component 44, such as but not limited to a video disk device. The processor 40 may communicate general data with other devices in the system 10 through one or more transceivers 46 (only one transceiver shown for clarity), which may be a wireless transceiver such as but not limited to WiFi transceiver, Bluetooth transceiver, and the like. The processor 40 may communicate video data through a video input/output interface 48 such as a high definition multimedia interface (HDMI) interface to yet a fourth device 50 which may be implemented by a displayer of multimedia such as a TV having a complementary video input/output interface 52 for receiving the multimedia from the third device 38.

Accordingly, the device 50 may include a processor 54 accessing a disk-based or solid state computer readable storage medium 56 to execute logic for controlling a display 58 and speakers 60. The display 58 may be a high definition (HD) or ultra HD display, although standard definition displays may be used. The processor 54 may communicate general data with other devices in the system 10 through one or more transceivers 62 (only one transceiver shown for clarity), which may be a wireless transceiver such as but not limited to WiFi transceiver, Bluetooth transceiver, and the like. The processor 54 may receive user voice signals through a microphone 64 and may receive user images from a camera 66. User commands may be wirelessly sent to the processor 54 from a hand held remote control 67.

A fifth device 68 which may be implemented by a tablet or laptop or notebook computer may include a processor 70 accessing a disk-based or solid state computer readable storage medium 72 to execute logic for controlling a video display 74 to output data, typically in the form of images and user interfaces, thereon. The processor 70 may communicate general data with other devices in the system 10 through one or more transceivers 76 (only one transceiver shown for clarity), which may be a wireless transceiver such as but not limited to WiFi transceiver, Bluetooth transceiver, and the like. The processor 70 may receive user input from one or more user input devices 78 such as keyboards, keypads, mice, trackballs, other point-and-click devices, voice recognition software operating on audio captured by a microphone (not shown), touch capability of the display 74, and so on.

A sixth device 80 which may be implemented by an in vivo apparatus such as an in vivo drug dispenser or blood sensor or other body sensor may include a processor 82 accessing a disk-based or solid state computer readable storage medium 84 to execute logic for controlling a drug injection component 86, such as but not limited to an electrically-actuated plunger of a small syringe 86 or other drug dispensing component. The processor 82 may communicate general data with other devices in the system 10 through one or more transceivers 90 (only one transceiver shown for clarity), which may be a wireless transceiver such as but not limited to WiFi transceiver, Bluetooth transceiver, and the like. In addition or alternatively to the drug injection component 86 the processor 82 may receive sensor information from one or more body sensors 88. Without limitation the body sensor 88 may be a temperature sensor, blood gas sensor, oxygen sensor, blood glucose sensor, etc.

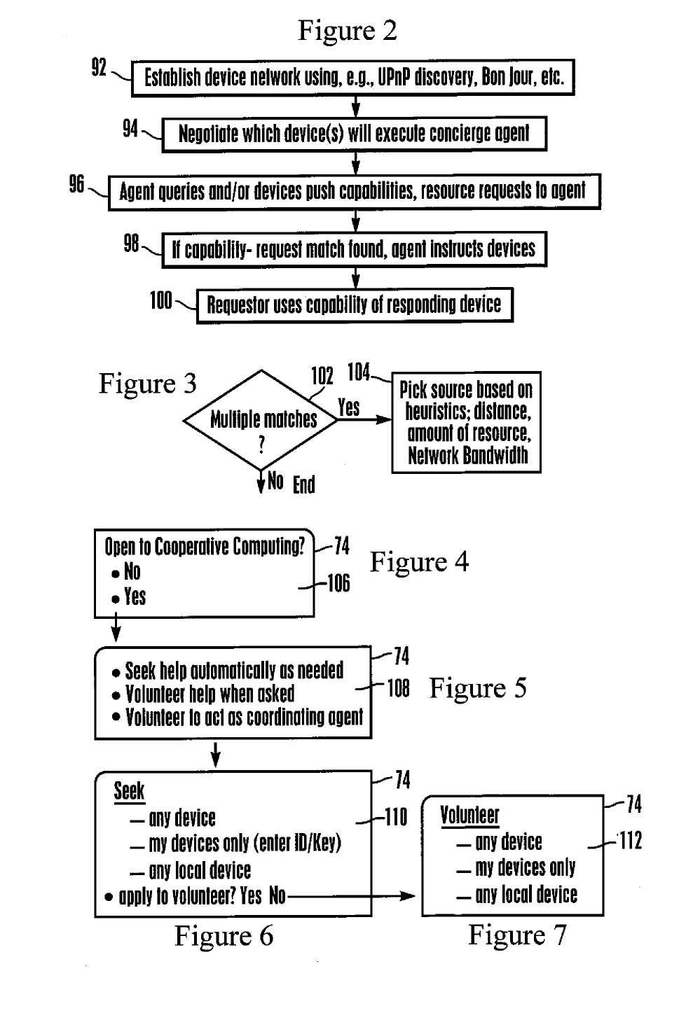

FIG. 2 shows that at block 92, a network such as that shown in FIG. 1 may be automatically established using device discovery protocol such as universal plug-n-play (UPnP) discovery, the so-called Bonjour discovery process, Bluetooth discovery, etc. It will be appreciated that in such implementations the network so constructed by devices discovering each other is local and ad hoc. However, as discussed further below in terms of some example user interfaces (UI), a user may define which devices are in the network.

Proceeding to block 94, the devices in the system 10 can negotiate with each other as to which device will execute the below-described coordination or concierge agent. In other implementations, a user defining the system 10 in terms of the devices that are in it can also define which device will execute the agent.

Moving to block 96, the agent, typically executed by one of the processors in the system, can query devices as to which capabilities they have to lend to other devices, and which requirements or functionalities they may have to execute and thus to request of other devices. In addition or alternatively the various system devices in the network can push capabilities and requests to the agent as the need/capacity arises.

In response to a request for a service functionality from a first device, at block 98 the agent determines if another device in the network is capable of satisfying the request. If a match is found, the agent informs both devices of the fact and instructs the requesting device to communicate with the supplying device to obtain the required service or functionality. At block 100 the requesting device uses the capability of the providing (responding) device to execute the programmed task of the requesting device.

FIG. 3, decision diamond 102 illustrates that if the agent determines that multiple matches exist to satisfy a request at block 98 in FIG. 2, the logic flows to block 104 to select a providing source device based on one or more selection rules. For instance, the geometrically nearest (to the requestor) providing source may be selected, or the providing source with the largest capability of the requested resource/functionality (e.g., storage space) may be selected, or the providing source having the largest bandwidth path communication with the requestor may be selected.

FIGS. 4-7 illustrate various example UIs for implementing the above principles. While the UIs are shown being visually presented on the display 74 of the computer 68, it is to be understood that they can be presented on any device in the network having audio or video display capability.

FIG. 4 shows an initial UI 106 which gives the user the option of configuring the device to participate in the above-described cooperative functionality sharing logic of FIGS. 2 and 3. Selecting “no” prevents, for example, the device from engaging in the auto discovery logic at block 92 of FIG. 2.

Selecting “yes” on the UI 106 may cause the UI 108 of FIG. 5 to appear. As shown, the UI 108 gives the user plural options for selecting functionality sharing behaviors. In the example shown, the user can configure the device to automatically seek help from other devices (through the above-described agent in some embodiments) in the network when needed, and/or to automatically volunteer capabilities or other help or aid (through the above-described agent in some embodiments). The user can also configure the device to volunteer to host the agent described above. In other words, in some embodiments a user, who may be associated with all the devices in a local network, can configure which device is to host the agent, as opposed to leaving the decision as to where the agent is hosted to the devices themselves as can otherwise be done at block 94 of FIG. 2.

Assuming the user has selected “yes” from the UI 106 of FIG. 4 and then has configured the device as desired using the UI 108 of FIG. 5, the UI 110 of FIG. 6 may be presented to allow the user to define in greater depth the behavior of the device in seeking help when needed. As shown, the user may configure the device to seek help from any device with which the device being configured can communicate, or to seek help only from a list of user-defined devices. In this latter case the user may define the list by entering appropriate device IDs/addresses/authentication keys. Yet again, the user may configure the device to seek help from any local device, for example, from any device with which the device being configured can communicate using a short range transceiver such as Bluetooth. This latter option recognizes that a user in a local setting such as a medical facility who can trust local devices may wish to simply allow device discovery to establish a local network as is done at block 92 in FIG. 2, relieving the user of the chore of manually defining the network membership.

As shown in the UI 110, the user may select to apply the above-described “seek help” options to volunteering functionality in the network. In the event that the user wishes the device to exhibit different behaviors as between seeking help and volunteering help, the user can select “no” in the UI 110 as shown which may cause the UI 112 of FIG. 7 to appear.

As shown, the user may configure the device to volunteer help to any device with which the device being configured can communicate responsive to a request for help from that device, or to volunteer help only from a list of user-defined devices. In this latter case the user may define the list by entering appropriate device IDs/addresses/authentication keys. Yet again, the user may configure the device to volunteer help to any local device, for example, to any device with which the device being configured can communicate using a short range transceiver such as Bluetooth. This latter option recognizes that a user in a local setting such as a medical facility who can trust local devices may wish to simply allow device discovery to establish a local network as is done at block 92 in FIG. 2, relieving the user of the chore of manually defining the network membership.

Following are example use cases that exploit the concepts described above.

In dynamic resourcing, a specific need or task (e.g., memory, display, decoding, encoding, formatting, etc.) is communicated from a requesting device to the network of devices. Each device may self-query for availability of its functional ability to assist the requesting device, responding to the request as appropriate. As discussed above, an agent on the network can repeatedly query devices for the availability of functions, sourcing the functions as needed.

Thus, cloud networking can be used for remote processing. In specific examples, a device such as the ingestable camera 12 of FIG. 1 can offload image data for offloading image analysis and processing to, e.g., the computer 68 so that the computer 68 can output a diagnosis of the patient based on the outcome of the processing of images from the camera 12. Medical monitoring/medical therapeutics can be enhanced by using the monitor device 80 to send data representing monitored parameters (e.g., blood glucose) to the computer 68 to cause the computer 68 to analyze the data. If treatment is needed (e.g., as indicated by a blood glucose level satisfying a threshold level), the computer 68 can send a message to the in vivo device to activate the syringe 86 or other delivery mechanism to dispense medicament to the patient, e.g., insulin can be dispensed based on the blood glucose level. In any case, a specific need for help is communicated from a device and is dynamically resourced by adapting the availability of available devices to the needs, such that resources are dynamically shared.

Additional examples include using the wireless telephone 22 to advertise that it has a GPS sensor available for use, using the camera 12 to advertise that it has a live video feed to share, using the media player 38 to responsively query the camera 12 if the camera 12 desires its feed to be presented on a display associated with the media player, and using the computer 68 to responsively query the camera 12 if the camera 12 desires the computer 68 to save and record the video feed from the camera.

In some cases the camera 12 may not be ingestable but instead may be placed in a child's room as a baby monitor that can send its audio and video feed to a parent's computer 68. Images from the camera can be sent directly to a home device such as the TV 50 or computer 68, skipping transmission through the cloud, with the images from the camera being saved and/or presented on the TV or computer. In this way logins can be dispensed with as well as server traffic, with communication going directly to a device in the network which may be user-defined as described above. Yet again, the TV 50 can be used to initiate a phone call. The camera 66 and microphone 64 can be used to image a viewer and capture the viewer's voice, dialing, e.g., the phone 22 to complete a phone call from the TV 50 to the phone 22. Thus, camera sharing, audio sharing, sensor sharing (GPS, medical, and health), data storage sharing, back end functions and processes, etc. are enabled in the network described above.

In addition, discoveries and technical initiative can be shared across company divisions and product lines. Present principles enable a software based solution that requires relatively low overhead to develop. Specialized devices (such as in vivo monitors and cameras) can be augmented as such devices learn each others' specialties and seek utilization opportunities, thus augmenting the performance of individual devices. Devices can become open channels for event viewing including sporting events, classroom activities, and online presentations.

While the particular NETWORKED DEVICES MATCHING CAPABILITIES WITH TASKS is herein shown and described in detail, it is to be understood that the subject matter which is encompassed by the present invention is limited only by the claims.

What is claimed is:

1. Network device, comprising:
a computer processor;
a computer readable storage medium accessible to the processor and bearing instructions which when executed by the processor to cause the processor to execute logic comprising:
establish with at least a partner device a network;
record a network location of an agent;
communicate to the agent capabilities of the network device and/or requirements or functionalities required by the network device to request execution thereof by other devices in the network;
in response to a request for a service functionality from the partner device and responsive to a determination that the network device is capable of satisfying the request, supply to the partner device the service functionality; and/or in response to a reply to a request for a service functionality issued by the processor and responsive to a determination that the partner device is capable of satisfying the request, instruct the partner device to execute the service functionality.

2. The device of claim 1, wherein the processor is configured to establish the network automatically using a device discovery protocol.

3. The device of claim 2, wherein the network is local and ad hoc.

4. The device of claim 1, wherein the processor is configured to establish the network at least in part by using a user-input definition of which devices are to be in the network.

5. The device of claim 1, wherein devices in the network are configured to negotiate with each other as to which device will execute the agent.

6. The device of claim 1, wherein a network location for the agent is defined by user input.

7. Agent executing on a computing device to configure the computing device to execute method acts comprising:
receive from devices in a network requests for services;
receive from devices in the capabilities to perform services;
determine if a request for a service from a requesting device matches a capability of a first device and a second device;
responsive to a determination that the request for a service from the requesting device matches a capability of the first device but does not match the capability of the second device, cause the first device to supply the capability for the requesting device;
responsive to a determination that the request for a service from the requesting device matches a capability of the first device and matches a capability of the second device, select the first device to supply the capability for the requesting device based on at least one selection criterion.

8. The agent executing on the computing device of claim 7, wherein the selection criterion is that a distance from the first device to the requesting device is less than a distance between the second device and the requesting device.

9. The agent executing on the computing device of claim 7, wherein the selection criterion is that the first device possesses greater capability to satisfy the request for a service than the second device.

10. The agent executing on the computing device of claim 7, wherein the selection criterion is that a bandwidth of a network path between the first device and the requesting device is greater than a bandwidth of a network path between the second device and the requesting device.

11. Device, comprising:
a computer processor;
a display controlled by the processor; and
a computer readable storage medium accessible to the processor and bearing instructions which when executed by the processor to cause the processor to execute logic comprising:
present on the display a first user interface (UT) providing an option of configuring the device to participate in functionality sharing with other devices in a network; and
responsive to selection of configuring the device to participate in functionality sharing with other devices in the network, present on the display a second UI providing plural options for selecting functionality sharing behaviors.

12. The device of claim 11, wherein the second UI provides options to configure the device to automatically seek help from other devices in the network when needed, and/or to automatically volunteer capabilities or other help or aid.

13. The device of claim 12, wherein the second UI provides an option to configure the device to volunteer to host an agent coordinating functionality sharing between devices on the network.

14. The device of claim 11, wherein the device is a first device and the instructions when executed by the processor to cause the processor to execute logic comprising:
present on the display a third UI providing options to configure the first device to seek help from any device with which the first device can communicate, or to seek help only from a list of user-defined devices.

15. The device of claim 14, wherein the third UI provides an option for a user to define the list by entering appropriate device IDs and/or addresses and/or authentication keys.

16. The device of claim 14, wherein the third UI provides an option for a user to configure the first device to seek help from any device with which the first device can communicate using a short range wireless transceiver.

17. The device of claim 14, wherein the third UI provides an option to apply at least some of the options provided by the third UI to volunteering functionality in the network.

18. The device of claim 11, wherein the device is a first device and the instructions when executed by the processor to cause the processor to execute logic comprising:
present on the display a fourth UI providing options to configure the first device to volunteer help to any second device with which the first device can communicate responsive to a request for help from the second device, or to volunteer help only from a list of user-defined devices.

19. The device of claim 18, wherein the fourth UI provides an option to configure the first device to volunteer help to any second device with which the first device can communicate using a short range transceiver.

20. The device of claim 1, wherein the device is an ingestable camera and/or an in vivo medical monitor and/or an in vivo drug delivery device.
